(19) United States
(12) Patent Application Publication
(10) Pub. No.: US 2003/0168539 A1
(43) Pub. Date: Sep. 11, 2003

(54) Refiner and method for treating the surface of a tool of a refiner of this type

(76) Inventors: Ulrich Schoof, Dusseldorf (DE); Stefan Reimann, Neuss (DE)

Correspondence Address: GREENBLUM & BERNSTEIN, P.L.C., 1950 ROLAND CLARKE PLACE, RESTON, VA, 20191, US

(21) Appl. No.: 10/297,603

(22) PCT Filed: Jun. 26, 2001
(86) PCT No.: PCT/EP01/07300

(51) Int. Cl. B02C 7/12

(52) U.S. Cl. 241/298

(57) ABSTRACT

The invention relates to a refiner and a process for treating, i.e. surface treating a tool of the refiner with the aid of a treatment in a plasma-based process with the addition of foreign ions and the addition of an additional hard material layer on the surface of the tool, in order to make it more wear-resistant.

In the paper and/or pulp industry, so-called refiners are used with the aid of which, e.g., wood pulp and/or cellulose and rag pulp and recycling material can be refined. To this end, the refiners need a tool, i.e., a refining tool, which, depending on the shape of the refiner, e.g., a conical refiner or a disc refiner, is embodied as a cone, or disc or segment. These elements are subjected to a very high degree of wear. Attempts have therefore been made for a long time to increase the stability of such tools. For this reason great attention has hitherto been paid to the choice of material and therefore such tools have been made of, e.g., acid-resistant steels and/or cast materials. Tools made of steel are hardened, e.g., at least on the stressed surface.

The object of the invention is to create or propose a refining tool and a process through which the tool of the refiner can be strengthened by means of a targeted treatment with long lasting effect.

This object is attained with a refiner according to the invention in that first, foreign ions are embedded in the surface of the active face of the tool with a penetration depth of up to 500 μm by means of a plasma-based process and an additional hard material layer is added to the surface. The foreign ion addition is made by accelerated ions with defined energy. The foreign ions to be implanted are deposited in the material surface in a reactive plasma. The number of implanted foreign ions and their penetration depth can be varied by means of corresponding concentrations of the foreign ions, i.e., the number of implanted foreign ions and their penetration depth can be determined exactly and depends on the materials used and the energy of the foreign ions. Such an approach has advantages in that only a few parameters need to be taken into consideration in the process, i.e., the dose of foreign ions, the particle energy and the bombarding time. The process can thus be well controlled and the result can be easily reproduced. In addition, a hard material layer is added, which provides the additional advantage that the surface structure is compressed.

Advantageous embodiment features of the invention are contained in the dependent claims, in particular regarding the composition of the foreign ions on the one hand and of the hard material layer on the other.

The procedural approach is particularly important for the current invention, according to which embedding foreign ions in the surface of the tool and adding a hard material layer on the surface occur in one work step.

Cones in a conical refiner or discs or segments in a disc refiner or double-disc refiner can be considered as a tool in the context of the current invention.

1. Refiner with a tool made of an iron material, preferably cast material, surface-treated for the purpose of reducing wear, characterized in that foreign ions are embedded with a penetration depth of up to 500 μm at least in the surface of the active face of the tool by means of a plasma-based procedure and an additional hard material layer is added to the surface of the tool.

2. Refiner according to claim 1, characterized in that nitrogen, carbon, molybdenum, titanium, tungsten, vanadium or boron ions are embedded as foreign ions.

3. Refiner according to claim 1, characterized in that the hard material layer features nitrite, carbide and/or oxide, carbonitride and/or oxycarbonitride the elements of Groups IV b, V b, VI b of the Periodic Table or of a nitride of the elements boron, aluminum, silicon, molybdenum, tungsten or of a titanium carbonitride and/or titanium nitrite.

4. Refiner according to one or more of claims 1 through 3, characterized in that the tool is embodied as a cone or as a disc or segment.

5. Process for surface treatment of a tool of a refiner, characterized in that imbedding foreign ions in the surface of the tool and adding a hard material layer on the surface occur in one work step.
